(19) United States
(12) Patent Application Publication
(10) Pub. No.: US 2024/0289216 A1
(43) Pub. Date: Aug. 29, 2024

(54) BALANCED ERROR CORRECTION CODE INCLUDING EXPLICIT QUANTIZED KNUTH INDEX

(71) Applicant: Micron Technology, Inc., Boise, ID (US)

(72) Inventor: Christophe Vincent Antoine Laurent, Agrate Brianza (MB) (IT)

(21) Appl. No.: 18/443,764

(22) Filed: Feb. 16, 2024

Related U.S. Application Data
(60) Provisional application No. 63/486,553, filed on Feb. 23, 2023.

(51) Int. Cl. G06F 11/10

(52) U.S. Cl. CPC G06F 11/1068; G06F 11/1004

(57) ABSTRACT

In some aspects, the techniques described herein relate to a method including: generating quantized Knuth (QK) index bits for a codeword, the QK index bits selected from a list of QK bits; computing a parity portion based on the payload and the QK index bits; combining the payload, parity portion, and the QK index bits to form a codeword; and writing the codeword to a memory device.

### CROSS-REFERENCE TO RELATED APPLICATIONS

This application claims the benefit of U.S. Prov. App. No. 63/486,553, filed Feb. 23, 2023, which is incorporated by reference in its entirety.

### TECHNICAL FIELD

At least some embodiments disclosed herein relate to memory systems in general and, more particularly but not limited to, techniques for balancing and performing error correction on codewords stored in such memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

A memory device can include a memory integrated circuit having one or more arrays of memory cells formed on an integrated circuit die of semiconducting material. A memory cell is the smallest unit of memory that can be individually used or operated upon to store data. In general, a memory cell can store one or more bits of data.

Different types of memory cells have been developed for memory integrated circuits, such as random-access memory (RAM), read-only memory (ROM), dynamic random access memory (DRAM), static random access memory (SRAM), synchronous dynamic random access memory (SDRAM), phase change memory (PCM), magneto random access memory (MRAM), negative-or (NOR) flash memory, electrically erasable programmable read-only memory (EEPROM), flash memory, etc.

Some integrated circuit memory cells are volatile and require power to maintain data stored in the cells. Examples of volatile memory include Dynamic Random-Access Memory (DRAM) and Static Random-Access Memory (SRAM).

Some integrated circuit memory cells are non-volatile and can retain stored data even when not powered. Examples of non-volatile memory include flash memory, Read-Only Memory (ROM), Programmable Read-Only Memory (PROM), Erasable Programmable Read-Only Memory (EPROM) and Electronically Erasable Programmable Read-Only Memory (EEPROM) memory, etc. Flash memory includes negative-and (NAND) type flash memory or a negative-or (NOR) type flash memory. A NAND memory cell is based on a NAND logic gate; and a NOR memory cell is based on a NOR logic gate.

Cross-point memory (e.g., 3D XPoint memory) uses an array of non-volatile memory cells. The memory cells in cross-point memory are transistor-less. Each of such memory cells can have a selector device and optionally a phase-change memory device that are stacked together as a column in an integrated circuit. Memory cells of such columns are connected in the integrated circuit via two layers of wires running in directions that are perpendicular to each other. One of the two layers is above the memory cells; and the other layer is below the memory cells. Thus, each memory cell can be individually selected at a cross point of two wires running in different directions in two layers. Cross point memory devices are fast and non-volatile and can be used as a unified memory pool for processing and storage.

### BRIEF DESCRIPTION OF THE DRAWINGS

The embodiments are illustrated by way of example and not limitation in the figures of the accompanying drawings in which like references indicate similar elements.

FIG. 1 is a diagram illustrating a quantized Knuth (QK) transformation.

FIG. 2 is a flow diagram illustrating a method for building a perfectly balanced message using an explicit quantized Knuth index.

FIG. 3 is a flow diagram illustrating a method for reading a perfectly balanced message.

FIG. 4 is a flow diagram illustrating a method for constructing a special Gray list.

FIG. 5 is an example of generating a special Gray list using the method of FIG. 4.

FIG. 6 is a block diagram illustrating a memory system according to some embodiments of the disclosure.

FIG. 7 is a block diagram illustrating a computing device showing an example of a client or server device used in the various embodiments of the disclosure.

### DETAILED DESCRIPTION

The disclosed embodiments relate to balancing codewords stored in a memory device while not requiring an increase in the correction power of an error code correction (ECC) engine. The disclosed embodiments achieve this by performing a QK procedure and storing the QK index directly in the codeword as a specifically-encoded value. In some implementations, the disclosed embodiments may not require an increase in the number of parity bits despite the inclusion of additional data (i.e., the QK index) depending on the dimensionality of the payload and do not require increased hardware complexity of the underlying ECC engine.

In some memory systems, the use of a QK index increases the required error correction capability due to the introduction of errors in codewords. For example, in some systems, a QK index is not stored in the codeword and parity bits are added. Then, during decoding, a default QK index value (e.g., zero) is used and this intentional error is corrected using the parity. Details of such an approach are described in commonly-owned application having Atty. Docket No. 120426-010500. In contrast to such approaches, the disclosed embodiments retains an explicit QK index in the codeword itself and thus does not inherently introduce an extra error into the codeword. As such, the number of memory cells requires to save the QK index can be equal or lower than the one required to retrieve it using other techniques.

In some aspects, the techniques described herein relate to a method including: generating quantized Knuth (QK) index bits for a codeword, the QK index bits selected from a list of QK bits; computing a parity portion based on the payload and the QK index bits; combining the payload, parity portion, and the QK index bits to form a codeword; and writing the codeword to a memory device.

In some aspects, the techniques described herein relate to a method, wherein generating the QK index bits includes selecting a Gray coding from a special Gray list.

In some aspects, the techniques described herein relate to a method, further including generating the special Gray list by: receiving a number of packets; generating a Gray coding; trimming the Gray coding to obtain a special Gray list; and iteratively identifying and removing successive values in the special Gray list to reduce a size of the special Gray list to a size equal to the number of packets.

In some aspects, the techniques described herein relate to a method, wherein the number of packets is identified based on a Hamming distance of an error correction code (ECC).

In some aspects, the techniques described herein relate to a method, wherein combining the payload, parity portion, and the QK index bits to form a codeword includes concatenating the payload, parity portion, and QK index bits.

In some aspects, the techniques described herein relate to a method further comprising adding one or more padding bits to the codeword.

In some aspects, the techniques described herein relate to a method, wherein selecting the QK index bits includes selecting a binary coding of a number of QK index bits.

In some aspects, the techniques described herein relate to a method, wherein the codeword includes a plurality of packets and the method further including inverting a subset of the plurality of packets to obtain a QK index.

In some aspects, the techniques described herein relate to a method, further including distributing the QK index bits among the plurality of packets.

In some aspects, the techniques described herein relate to a method including: reading a codeword from a memory device; performing error correction on the codeword using an error code correction (ECC) engine; extracting quantized Knuth (QK) index bits from the codeword; inverting a subset of the codeword based on the QK index bits to obtain a payload; and returning the payload to a host processor.

In some aspects, the techniques described herein relate to a method, wherein the codeword includes an inverted payload, wherein a subset of a plurality of packets forming the codeword are inverted.

In some aspects, the techniques described herein relate to a method, wherein inverting a subset of the codeword based on the QK index bits includes inverting a first subset of successive packets of the plurality of packets based on the QK index bits.

In some aspects, the techniques described herein relate to a method, including converting the QK index bits to a QK index using a special Gray list, the special Gray list including a Gray list beginning with a first value and ending with a second value comprising an inverse of the first value, wherein a size of the special Gray list is equal to a size of the plurality of packets.

In some aspects, the techniques described herein relate to a method, wherein performing error correction on the codeword includes correcting an error in the QK index bits.

In some aspects, the techniques described herein relate to a method including: receiving a number of packets; generating a Gray coding; trimming the Gray coding to obtain a special Gray list; and iteratively identifying and removing successive values in the special Gray list to reduce a size of the special Gray list to a size equal to the number of packets.

In some aspects, the techniques described herein relate to a method, wherein trimming the Gray coding includes identifying an ending value that is the inverse of a first value of the special Gray list and removing all Gray code values appearing after ending value.

In some aspects, the techniques described herein relate to a method, wherein generating a Gray coding includes generating the Gray coding using a binary-reflected Gray code (BRGC) algorithm.

In some aspects, the techniques described herein relate to a method, wherein iteratively identifying and removing successive values in the special Gray list further includes determining when a size of the special Gray list is equal to the number of packets and storing the special Gray list.

In some aspects, the techniques described herein relate to a method, wherein iteratively identifying and removing successive values in the special Gray list includes: identifying a pair of Gray code values, the pair of Gray code values appearing between a first Gray code value and second Gray code value; determining that the pair of Gray code values can be removed when the first Gray code value and second Gray code value can be adjacent to one another without affecting conformance with a Gray encoding; and removing the pair of Gray code values to generate a new special Gray list.

In some aspects, the techniques described herein relate to a method, wherein iteratively identifying and removing successive values in the special Gray list includes analyzing successive pairs of Gray code values from one of a beginning of the Gray coding or an ending of the Gray coding.

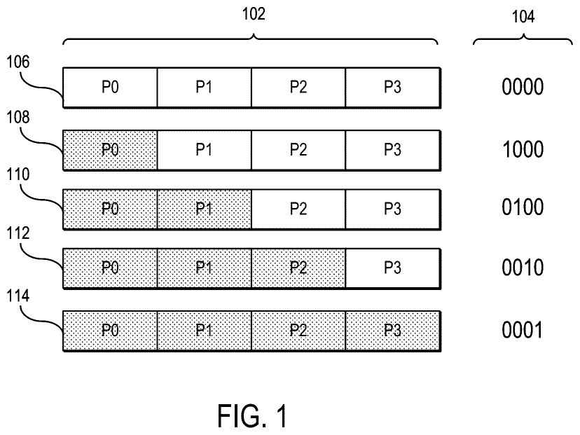

FIG. 1 is a diagram illustrating a quantized Knuth (QK) transformation.

In a QK transformation, a given codeword is quantized into packets. For example, payload 102 in FIG. 1 is quantized into four packets: P0, P1, P2, and P3. In general, the packets will have the same length, and one or more may be zero-padded if the codeword is not divisible by the packet length. In some implementations, the packet size may be selected based on the properties of an error correction code (ECC). For example, a Bose-Chaudhuri-Hocquenghem (BCH) code that can correct up to two errors may have a Hamming distance of five. In this scenario, a packet size equal to or larger than the Hamming distance of five may be used. In some implementations, the packets may contain user data as well as QK index bits. For example, P0 may include the left-most QK index bit (0), P1 may include QK index bits 1 and 2, P2 may include QK index bits 1 and 2, and P3 may include QK index bits 2 and 3.

The purpose of a QK transformation is to balance the ones and zeroes in the codeword by sequentially inverting the bits of packets until the ratio of ones to zeroes meets an error margin. To do this, the transformation starts with an uninverted payload 106. First, the QK algorithm inverts packet P0 and checks the resulting codeword 108. If the ratio of zeros to ones of the resulting codeword 108 does not meet the desired threshold, the algorithm inverts the next packet, P1, resulting in packets P0 and P1 both being inverted and the codeword 110. If the ratio of zeros to ones of codeword 110 does not meet the desired threshold, the algorithm continues similarly, inverting packet P2 to obtain codeword 112, inverting packet P3 to obtain codeword 114, etc.

As soon as the algorithm determines that the ratio of a payload meets the desired threshold, the algorithm ends and outputs a position. This position represents the last inverted packet in the payload and is illustrated as a one-hot encoding 104. Thus, as illustrated, the bits “0000” indicate no packets were inverted, the bits “1000” indicate P0 was inverted, “0100” indicates packets P0 and P1 were inverted, “0010” indicates P0 through P2 were inverted, etc. Although a one-hot encoding is illustrated, other encodings may be used. For example, if a binary encoding is used, only three bits are required to store the same information. Similarly, a standard Gray encoding requires three bits. As discussed in more detail below, various properties of the QK index can be exploited to reduce the total size of the bits needed to store a QK index.

Notably, the use of an error margin or threshold is needed since the ratio of ones to zeroes may not be precisely 1:1. Thus, the threshold will define a tolerance (e.g., 1:1.25) that may be used to terminate the algorithm.

When a system that employs a QK algorithm writes the payload, it writes the inverted bits. Thus, payload 110 includes inverted bits for P0 and P1 when written, despite corresponding to the uninverted payload 106. For this reason, the QK index (represented in one-hot encoding 104) must also be stored. This is because a read algorithm must invert P0 and P1 of payload 110 to obtain uninverted payload 106. To do this, it must be aware of which packets were flipped. Since the QK algorithm successively inverts packets, storing the identity of the last-inverted packet is sufficient. As discussed, in some implementations, the QK index bits may be included in the packets themselves.

Balanced codewords can help improve the efficiency of error correction algorithms, which can further enhance the reliability and performance of the device. Further, since packets are selected based on the Hamming distance of the ECC code, coherency between parity bits and the QK-processed payload is maintained. Notably, in the following examples, it may be presumed that an ECC algorithm is invariant, in that coherency is maintained regardless of whether packet bits are inverted. That is, the ECC algorithm will produce the same parity bit(s) for a packet or its inverse since inverting a packet transforms one valid codeword to another while maintaining ECC correction capabilities.

In some systems, QK index data is not persisted in memory. For example, if the QK index is stored in a one-hot encoding, during read operations, the QK index data could be presumed to be all zeros, and the ECC power increased to detect the error (if any) in the QK index data. Since a one-hot encoding uses only one bit, the increased ECC power will be able to re-create the QK index encoding, at the expense of more complex and time-consuming processing.

In the following description, a system, method, and computer-readable medium is described, which allows for a QK index value to be persisted in memory alongside a payload and parity bits while requiring minimal storage capacity for the index. Since the QK index is stored, additional ECC power is not required explicitly to re-construct the QK index.

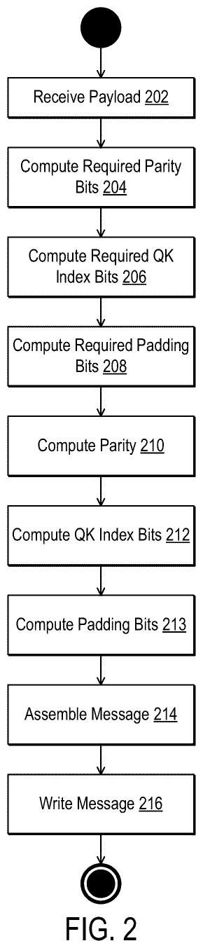

FIG. 2 is a flow diagram illustrating a method for building a perfectly balanced message using an explicit quantized Knuth index.

In step 202, the method can include receiving a payload. As used herein, a payload may refer to any form of data, such as binary data. No limit is placed on the contents of the payload or, necessarily, the length of the payload. For the following example, a 256-payload is used. In general, payload size is represented as k bits.

In step 204, the method can include computing the required number of parity bits for the payload and QK index bits. The number of parity bits required is represented as p bits.

In some implementations, the number of parity bits required will depend on the specific ECC used. Further, some ECC codes (e.g., BCH codes) can support variable-sized payloads while providing a guaranteed number of correctable (or detectable) errors. Thus, after determining the size of k+j, the method includes determining the total payload size and computing the number of parity bits needed by the underlying ECC code. For example, when using a BCH code, the number of parity bits can be deterministically chosen based on the properties (e.g., underlying finite field size and generator polynomial). Thus, the specific value of p may vary depending on implementations but will be able to be reliably calculated.

In step 206, the method can include computing or determining (if constants) how many QK index bits are required based on the size of the payload. The number of QK bits required is represented as j bits, thus the total number of user data and QK bits is represented as k+j bits.

In some implementations, step 206 can include determining how many packets of data are in the codeword. In some implementations, parity bits as well as QK index bits may also be included with user data in the packets. Further, in some implementations, individual QK index bits may be repeated in multiple packets (e.g., duplicated across two packets). In some implementations, a loop may be used to converge on the correct number of packets required. As discussed above, the packet size can be selected based on the Hamming distance of an underlying ECC algorithm. For example, a BCH2 code that can correct up to two errors in a given codeword has a Hamming distance of five bits. Thus, the packet size may be five or greater when using such an ECC code. In some implementations, the codeword may not be evenly divisible by the packet size, and thus one or more packets may include padding bits. In some implementations, the number of QK index bits can be deterministically chosen based on the choice of encoding of the QK index value, as will be discussed in more detail herein. In brief, based on the chosen number of QK index bits, a list of possible QK index values can be used and the total storage capacity used to represent that list can be determined.

In step 208, the method can include computing the required number of padding bits. The number of padding bits required is represented as x bits. In some implementations, the purpose of padding bits is to reach perfect balancing of the codeword. Prior to padding, a codeword may be nearly balanced, while the padding bits enable a fully balanced message. In some implementations, the number of padding bits is linked to the dimension of the largest packet size. Thus, the number of padding bits may be computed as taking one less than the largest packet dimension.

In step 210, the method can include computing parity bits for the payload and an all-zero QK index. In some implementations, the payload and all zero QK index are concatenated and passed through an ECC encoding matrix to generate parity bits using an ECC code. As discussed, the ECC code may comprise a BCH code capable of correcting up to two errors, although the specific ECC code is not limiting.

In step 212, the method can include computing QK index bits for the codeword received in step 202. As discussed, this step uses a QK algorithm (described in FIG. 1) to generate an index where the algorithm ceases inverting packets of the codeword. As will be discussed in more detail in later figures, the QK index bits can be encoded using a specialized encoding technique and references to QK index bits for the remainder of the description of this FIG. 2 presume encoded QK index bits.

In step 213, the method can include computing the padding bits. In some implementations, computing the padding bits can comprise generating a number of one or zero values based on the padding length computed in step 208. Although, in other embodiments, other permutations of ones and zeros may be used given the padding length.

In step 214, the method can include assembling a message. As used herein, a “message” refers to the bits of data transmitted to a memory array for storage. In some implementations, the message comprises a concatenation of the payload, the QK index bits, and the parity bits generated in the preceding steps. Further, the message may include the padding bits determined in step 208. In one specific implementation, the message may have the form payload∥QK index∥parity∥padding, although other arrangements may be suitable.

Finally, in step 216, the method can include writing the message to an underlying storage device. In some implementations, this storage device comprises a NAND Flash storage device. The specific operations for writing data to a NAND Flash device are not limiting and are not described in detail herein.

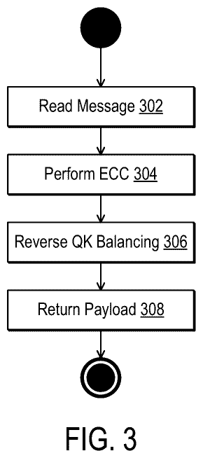

FIG. 3 is a flow diagram illustrating a method for reading a perfectly balanced message.

In step 302, the method can include reading a message. In some implementations, the method can read messages from an underlying NAND Flash storage device. In some implementations, the message can comprise a codeword built using the method of FIG. 2 and stored in the storage device.

In step 304, the method can include performing error correction on the codeword extracted from the message. As discussed above, the choice of ECC is not limited and may comprise, as one example, a BCH code capable of correcting up to two errors. In some implementations, step 304 can include detecting more than two errors while correcting two errors.

In step 306, the method can include reversing the QK balancing performed in the method of FIG. 2.

In one implementation, step 306 can include first reading the encoded QK index bits from the codeword. Next, the method can decode the QK index bits using a specialized decoding technique, described in more detail herein. After decoding the QK index bits to obtain the QK index of the last-inverted packet, step 306 can include sequentially inverting packets of codeword (from P0) as described (in opposite) in FIG. 1. As a result, after inverting the number of packets represented by the QK index, the method obtains the original payload.

Finally, in step 308 the method can return the payload to the calling device. For example, the method can return the payload to a host processor, host computer, etc. for further non-limiting uses.

In the various implementations discussed above, different encodings may be used to encode the QK index and generate QK index bits. Examples of appropriate encoding methods include binary coding, Gray coding, one-hot coding, thermometrical coding, etc. Certainly, the selected encoding method will have an impact on both the number of QK index bits and the number of packets required. That is, the number of bits will increase or decreasing depending on the encoding method used. A binary or Gray coding are both relatively compact and require few bits to represent the QK index. By contrast, one-hot and thermometrical codings require larger number of bits and thus more memory cells. For the following examples, a specialized Gray coding is used although the disclosure is not necessarily limited as such.

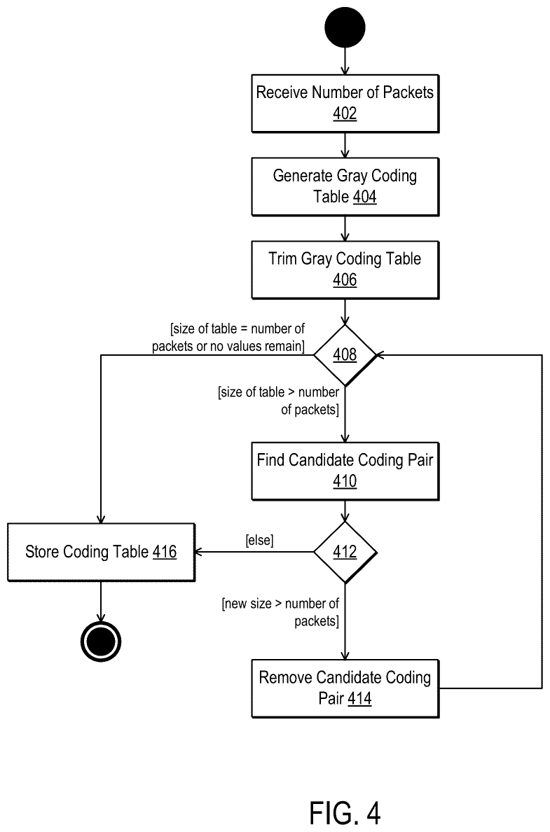

FIG. 4 is a flow diagram illustrating a method for constructing a special Gray list.

In some implementations, a special Gray list can be constructed to improve the performance of storing the QK index bits when storing them in a NAND Flash device. When using a Knuth algorithm, the encoding table must include a first and last value having opposite polarity. Thus, if the first value in a Gray list is 0000, the last value must be 1111. According to a Gray encoding, values present between the first and last value must only change one bit. Thus, if a message includes 36 packets, a list of 36 Gray-coded values, starting with 000000 and ending with 111111 comprises a special gray list. The following method of FIG. 4 illustrates a process for building such a list. Notably, since the length of the Gray codes may be fixed by the underlying storage mechanism, the special Gray list can be shortened when compared to a standard Gray list.

In step 402, the method can include receiving a required number of packets. In some implementations, this number of packets can be derived from the packet size and also the number of bits in the codeword or also by accounting for a number of bits that are used by several packets.

In step 404, the method can include generating a Gray coding table based on the number of packets. In some implementations, a well-known method for generating any type of Gray coding table can be used including, but not limited to, a binary-reflected Gray code (BRGC) algorithm. In general, a standard Gray code for a packet size will include more values than required to index the number of packets. For example, a five-bit Gray code may include 32 unique values while only a subset (e.g., 22) are needed (if, for example, 00000 and 11111 are used as the first and last values). Further, a standard Gray code will not include a final value that is the opposite polarity of the initial value. Notably, however, a Gray (or binary) code will begin with a zero value.

Consider, for example, a five-bit Gray code constructed using a BRGC algorithm:

TABLE 1

| No. | Code |
|---|---|
| 0 | 00000 |
| 1 | 00001 |
| 2 | 00011 |
| 3 | 00010 |
| 4 | 00110 |
| 5 | 00111 |
| 6 | 00101 |
| 7 | 00100 |
| 8 | 01100 |
| 9 | 01101 |
| 10 | 01111 |
| 11 | 01110 |
| 12 | 01010 |
| 13 | 01011 |
| 14 | 01001 |
| 15 | 01000 |
| 16 | 11000 |
| 17 | 11001 |
| 18 | 11011 |
| 19 | 11010 |
| 20 | 11110 |
| 21 | 11111 |
| 22 | 11101 |
| 23 | 11100 |
| 24 | 10100 |
| 25 | 10101 |
| 26 | 10111 |
| 27 | 10110 |
| 28 | 10010 |
| 29 | 10011 |
| 30 | 10001 |
| 31 | 10000 |

As can be seen, the Gray code will include 32 values. However, a method such as that in FIG. 2 may only require a subset of this number of values. Specifically, the number of packets in a codeword may be fewer than 32 and thus the following process reduces the length of the Gray list accordingly.

In step 406, the method can include trimming the Gray coding table. As discussed above, in some implementations, trimming the Gray coding table can include identifying a Gray code of opposite polarity as the initial code and removing all codes occurring after this row. For example, if the initial value is zero, in some implementations, this step includes identifying which Gray code is all ones and removing all Gray codes occurring after this all one value. However, the starting value may be any binary value provide the final value is its inverse. Thus, Table 1 may be trimmed as follows:

TABLE 2

| No. | Code |
|---|---|
| 0 | 00000 |
| 1 | 00001 |
| 2 | 00011 |
| 3 | 00010 |
| 4 | 00110 |
| 5 | 00111 |
| 6 | 00101 |
| 7 | 00100 |
| 8 | 01100 |
| 9 | 01101 |
| 10 | 01111 |
| 11 | 01110 |
| 12 | 01010 |
| 13 | 01011 |
| 14 | 01001 |
| 15 | 01000 |
| 16 | 11000 |
| 17 | 11001 |
| 18 | 11011 |
| 19 | 11010 |
| 20 | 11110 |
| 21 | 11111 |

As can be seen, rows 22 through 31 are removed from the code, leaving twenty two unique values and maintaining the opposite polarity requirement of the QK algorithm.

In step 408, the method can include determining if a stop condition is met. In some implementations, the stop condition can include checking if the size of the special Gray list meets the number of packets in a message. For example, if a message includes eight packets, step 408 can include determining if the special Gray list includes eight values. In some implementations, the method can alternatively check if the special Gray list includes either the number of packets or the number of packets plus one (e.g., 8 or 9 in the previous example). Alternatively, or in addition, the stop condition can include determining if any remaining values in the special Gray list can be removed. In some implementations, this check can be made if the special Gray list is larger than the number of packets (or the number of packets plus one). As will be discussed, the following sub-process can identify rows that may be removed.

In step 410, if none of the stop conditions pass, the method can find a candidate coding pair. As used herein, a candidate coding pair can comprise a pair of values that, if removed, would not destroy Gray code requirements. Specifically, the method can identify a pair of values that, when removed, result in a preceding and following Gray code value to meet the requirements of a Gray code.

Turning to Table 2, the first such pair comprises values at numbers 3 and 4 (“00010”) and (“00110”). Here, when these values are removed, the preceding value (2, “00011”) and following value (5, “00111”) would still meet the requirements of a Gray code (i.e., that one and only one bit is flipped when transitioning from 2 to 5. Although sequentially describe, the method may remove multiple values in a single pass provided that the removal of multiple pairs retains the requirements of a Gray code.

In some implementations, the method can perform step 410 for an entire list, identifying all possible candidates. In other implementations, after identifying the first candidate, the method can proceed to step 412. In step 412, the method determines if the size of the list when removing a pair meets the packet size requirements. Specifically, before removing a pair of values, the method computes the resulting size (e.g., current size minus two) and determines if the future size meets the packet requirement (as discussed in step 408). If not, the method can forego removing the pair and branch immediately to step 416. If the size is still within the desired range, the method can alternatively branch to step 414.

In step 414, the method removes the candidate pair from the list to generate a new special Gray list. The method then returns to step 408 and uses this new special Gray list for further iterations. Once the stop conditions in step 408 or 412 are met, the method finalizes the special Gray list and stores a coding table in step 416. In some implementations, the coding table may be stored in a memory device (e.g., in DRAM or in persistent storage) and used in the methods of FIG. 2 or 3 when encoding and decoding the QK index.

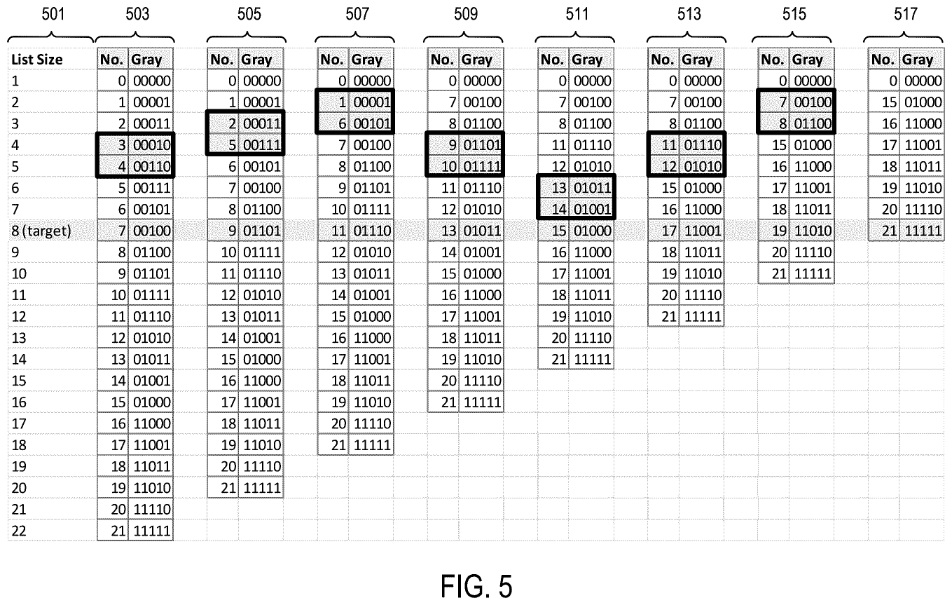

FIG. 5 is an example of generating a special Gray list using the method of FIG. 4.

In the example of FIG. 5, an initial trimmed Gray list 503 corresponding to Table 2 is illustrated. Further, a list of sizes 501 is provided to illustrate the “shrinking” of the initial trimmed Gray list 503. In the example, the number of packets in a message is eight, and thus row eight in list of sizes 501 is highlighted to illustrate convergence on that size.

During the first iteration, in step 408, the method determines that the size of the initial trimmed Gray list 503 (twenty-two) is larger than the number of packets (eight). Thus, the method executes step 410 on the initial trimmed Gray list 503 and identifies numbers three and four (identified with a bold outline) as a candidate pair since numbers 2 (00011) and five (00111) would still satisfy Gray code requirements. The method then checks the size (step 412) and determines that twenty is greater than eight and then removes numbers three and four to generate a new special Gray list 505. This process then repeats, as discussed, to generate list 507, list 509, list 511, list 513, list 515, and list 517.

When the method receives list 517 in step 408, the method determines that the size of list 517 is equal to the desired number of packets. As such, the method will end and store the list 517 as the special Gray list coding table in step 416. While the foregoing embodiments illustrate a ‘top down’ inspection of the Gray lists, the alternative (e.g., a bottom-up approach) may also be used in a similar fashion.

The foregoing process can yield an adjustable-sized special Gray list that can be generated based on the underlying packet dimensions. Table 3 below illustrates the number of bits in the Gray code corresponding to the number of packets (i.e., the size of the special Gray list):

TABLE 3

| Number of | |
|---|---|
| Gray Codes | Required Bits |
| 2 | 1 |
| 3 | 2 |
| 4 | 3 |
| 5 | 4 |
| 6 | 3 |
| 7 | 4 |
| 8 | 5 |
| 9 | 4 |
| 10 | 5 |
| 11 | 4 |
| 12 | 5 |
| 13 | 6 |
| 14 | 5 |
| 15 | 6 |
| 16 | 5 |
| 17 | 6 |
| 18 | 5 |
| 19 | 6 |
| 20 | 5 |
| 21 | 6 |
| 22 | 5 |
| 23 | 6 |
| 24 | 7 |
| 25 | 6 |
| 26 | 7 |
| 27 | 6 |

As discussed above, the length of the special Gray list may be fixed by two separate requirements. First, the desired number of packets and the Hamming distance of the code (since the packet's dimension can't be smaller than the Hamming distance) if the smallest packet is desired. In the first scenario, the length of the list is equal to the desired number of packets. In the second case, the packets are made as small as possible and the number of packets is a function of the payload length.

Consider, for example, a 128-bit payload protected by a BCH-2 code (e.g., a BCH code that can correct up to two errors). In this scenario, the number of parity bits required is 16, and the Hamming distance is five. Thus, the number of packets required in this scenario will be 36 (144/(5-1). To support 36 packets, seven QK index bits are required. Thus, the method of FIG. 4 will be executed to generate the special Gray list with seven bits and 36 packets. The final size of the message will thus be 155 bits (128 user bits, 16 parity bits, and seven QK index bits, plus four padding bits to enable evenly sized packets).

In some implementations, if the number of bits in the payload and parity (combined) is not a multiple of the number of available bits in each packet (e.g., the Hamming distance minus one), the last packet may be filled with QK index bits. In this scenario, the special Gray list must be modified to complete the last packet. In this scenario, the last elements of the resulting Gray list may switch more bits, thus deviating from the Gray encoding requirements. For example, if the final three Gray codes of a list are 01011, 11011, and 11111, the penultimate value (11011) may be removed resulting in 01011 and 11111 finishing the list, which violates the Gray coding scheme but may be sufficient for coding the QK index in this specific scenario.

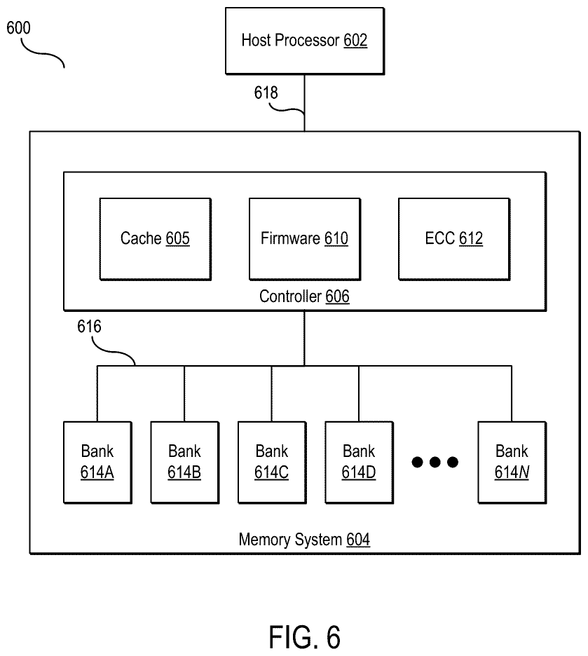

FIG. 6 is a block diagram illustrating a memory system according to some embodiments of the disclosure.

As illustrated in FIG. 6, a computing system 600 includes a host processor 602 communicatively coupled to a memory system 604 via a bus 618. The memory system 604 comprises a controller 606 communicatively coupled to one or more memory banks 614A-614N, forming a memory array via a bus/interface 616. As illustrated, controller 606 includes a local cache 605, firmware 610, and an error correction code (ECC) module 612.

In the illustrated embodiment, a host processor 602 can comprise any type of computer processor, e.g., a central processing unit (CPU), graphics processing unit (GPU), or other types of general-purpose or special-purpose computing devices. The host processor 602 includes one or more output ports that allow for the transmission of address, user, and control data between the host processor 602 and the memory system 604. In the illustrated embodiment, this communication is performed over the bus 618. In one embodiment, the bus 618 comprises an input/output (I/O) bus or a similar type of bus.

The memory system 604 is responsible for managing one or more memory banks 614A-614N. In one embodiment, the banks 614A-614N comprise NAND Flash dies or other configurations of non-volatile memory. In one embodiment, the memory banks 614A-614N comprise a memory array.

The banks 614A-614N are managed by the controller 606. In some embodiments, controller 606 comprises a computing device configured to mediate access to and from banks 614A-614N. In one embodiment, controller 606 comprises an ASIC or other circuitry installed on a printed circuit board housing the banks 614A-614N. In some embodiments, the controller 606 may be physically separate from the banks 614A-614N. Controller 606 communicates with the banks 614A-614N over interface 616. In some embodiments, this interface 616 comprises a physically wired (e.g., traced) interface. In other embodiments, the interface 616 comprises a standard bus for communicating with banks 614A-614N.

Controller 606 comprises various modules 605-612. In one embodiment, the various modules 605-612 comprise various physically distinct modules or circuits. In other embodiments, the modules 605-612 may completely (or partially) be implemented in software or firmware.

As illustrated, firmware 610 comprises the core of the controller and manages all operations of the controller 606. Firmware 610 may implement some or all the methods described above.

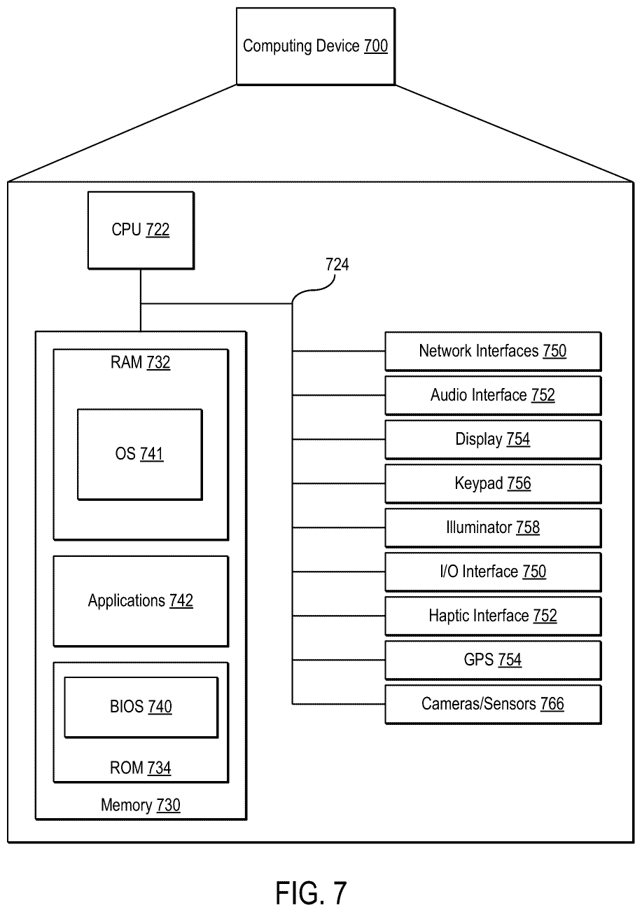

FIG. 7 is a block diagram illustrating a computing device showing an example of a client or server device used in the various embodiments of the disclosure.

The computing device 700 can include more or fewer components than those shown in FIG. 7, depending on the deployment or usage of the device 700. For example, a server computing device, such as a rack-mounted server, may not include audio interfaces 752, displays 754, keypads 756, illuminators 758, haptic interfaces 762, Global Positioning Service (GPS) receivers 764, or cameras/sensors 766. Some devices can include additional components not shown, such as graphics processing unit (GPU) devices, cryptographic co-processors, artificial intelligence (AI) accelerators, or other peripheral devices.

As shown in the figure, device 700 includes a central processing unit (CPU) 722 in communication with a mass memory 730 via a bus 724. The computing device 700 also includes one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal, or electromagnetic sensors 766. Device 700 can include one camera/sensor 766 or a plurality of cameras/sensor 766. The positioning of the camera(s)/sensor(s) 766 on the device 700 can change per device 700 model, per device 700 capabilities, and the like, or some combination thereof.

In some embodiments, the CPU 722 can comprise a general-purpose CPU. The CPU 722 can comprise a single-core or multiple-core CPU. The CPU 722 can comprise a system-on-A-chip (SoC) or a similar embedded system. In some embodiments, a GPU can be used in place of, or in combination with, a CPU 722. Mass memory 730 can comprise a dynamic random-access memory (DRAM) device, a static random-access memory device (SRAM), or a Flash (e.g., NAND Flash) memory device. In some embodiments, mass memory 730 can comprise a combination of such memory types. In one embodiment, the bus 724 can comprise a Peripheral Component Interconnect Express (PCIe) bus. In some embodiments, the bus 724 can comprise multiple buses instead of a single bus.

Mass memory 730 illustrates another example of computer storage media for the storage of information such as computer-readable instructions, data structures, program modules, or other data. Mass memory 730 stores a basic input/output system (“BIOS”) 740 for controlling the low-level operation of the computing device 700. In the illustrated embodiment, the BIOS 740 may be stored in a read-only memory (ROM) such as ROM 734. The mass memory also stores an operating system 741 for controlling the operation of the computing device 700

Applications 742 can include computer-executable instructions which, when executed by the computing device 700, perform any of the methods (or portions of the methods) described previously in the description of the preceding figures. In some embodiments, the software or programs implementing the method embodiments can be read from a hard disk drive (not illustrated) and temporarily stored in RAM 732 by CPU 722. CPU 722 can then read the software or data from RAM 732, process them, and store them in RAM 732 again.

The computing device 700 can optionally communicate with a base station (not shown) or directly with another computing device. Network interface 750 is sometimes known as a transceiver, transceiving device, or network interface card (NIC).

The audio interface 752 produces and receives audio signals such as the sound of a human voice. For example, the audio interface 752 can be coupled to a speaker and microphone (not shown) to enable telecommunication with others or generate an audio acknowledgment for some action. Display 754 can be a liquid crystal display (LCD), gas plasma, light-emitting diode (LED), or any other type of display used with a computing device. Display 754 can also include a touch-sensitive screen arranged to receive input from an object such as a stylus or a digit from a human hand.

Keypad 756 can comprise any input device arranged to receive input from a user. Illuminator 758 can provide a status indication or provide light.

The computing device 700 also comprises an input/output interface 760 for communicating with external devices, using communication technologies, such as USB, infrared, Bluetooth®, or the like. The haptic interface 762 provides tactile feedback to a user of the client device.

The optional GPS receiver 764 can determine the physical coordinates of the computing device 700 on the surface of the Earth, which typically outputs a location as latitude and longitude values. GPS receiver 764 can also employ other geo-positioning mechanisms, including, but not limited to, triangulation, assisted GPS (AGPS), E-OTD, CI, SAI, ETA, BSS, or the like, to further determine the physical location of the computing device 700 on the surface of the Earth. In one embodiment, however, the computing device 700 can communicate through other components, providing other information that can be employed to determine the physical location of the device, including, for example, a MAC address, IP address, or the like.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to the desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product or software that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as read-only memory (“ROM”), random access memory (“RAM”), magnetic disk storage media, optical storage media, flash memory components, etc.

In this description, various functions and operations are described as being performed by or caused by computer instructions to simplify the description. However, those skilled in the art will recognize what is meant by such expressions is that the functions result from the execution of the computer instructions by one or more controllers or processors, such as a microprocessor. Alternatively, or in combination, the functions and operations can be implemented using special-purpose circuitry, with or without software instructions, such as using Application-Specific Integrated Circuit (ASIC) or Field-Programmable Gate Array (FPGA). Embodiments can be implemented using hardwired circuitry without software instructions or in combination with software instructions. Thus, the techniques are limited neither to any specific combination of hardware circuitry and software nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

We claim:

1. A method comprising:
computing a parity portion based on a payload and quantized Knuth (QK) index bits for a codeword;
combining the payload, parity portion, and the QK index bits to form a codeword; and
writing the codeword to a memory device.

2. The method of claim 1, further comprising generating the QK index bits by selecting a Gray coding from a special Gray list.

3. The method of claim 2, further comprising generating the special Gray list by:
receiving a number of packets;
generating a Gray coding;
trimming the Gray coding to obtain a special Gray list; and
iteratively identifying and removing successive values in the special Gray list to reduce a size of the special Gray list to a size equal to the number of packets.

4. The method of claim 3, wherein the number of packets is identified based on a Hamming distance of an error correction code (ECC).

5. The method of claim 1, wherein combining the payload, parity portion, and the QK index bits to form a codeword comprises concatenating the payload, parity portion, and QK index bits.

6. The method of claim 5, further comprising adding one or more padding bits to the codeword.

7. The method of claim 1, wherein selecting the QK index bits comprises selecting a binary coding of a number of QK index bits.

8. The method of claim 1, wherein the codeword comprises a plurality of packets and the method further comprising inverting a subset of the plurality of packets to obtain a QK index.

9. The method of claim 8, further comprising distributing the QK index bits among the plurality of packets.

10. A method comprising:
performing error correction on a codeword using an error code correction (ECC) engine;
extracting quantized Knuth (QK) index bits from the codeword;
inverting a subset of the codeword based on the QK index bits to obtain a payload; and
returning the payload to a host processor.

11. The method of claim 10, wherein the codeword comprises an inverted payload, wherein a subset of a plurality of packets forming the codeword are inverted.

12. The method of claim 11, wherein inverting a subset of the codeword based on the QK index bits comprises inverting a first subset of successive packets of the plurality of packets based on the QK index bits.

13. The method of claim 12, comprising converting the QK index bits to a QK index using a special Gray list, the special Gray list comprising a Gray list beginning with a first value and ending with a second value comprising an inverse of the first value, wherein a size of the special Gray list is equal to a size of the plurality of packets.

14. The method of claim 10, wherein performing error correction on the codeword comprises correcting an error in the QK index bits.

15. A method comprising:
receiving a number of packets;
generating a Gray coding;
trimming the Gray coding to obtain a special Gray list; and
removing successive values in the special Gray list to reduce a size of the special Gray list to a size equal to the number of packets.

16. The method of claim 15, wherein trimming the Gray coding comprises identifying an ending value that is an inverse of a first value of the special Gray list and removing all Gray code values appearing after the ending value.

17. The method of claim 15, wherein generating a Gray coding comprises generating the Gray coding using a binary-reflected Gray code (BRGC) algorithm.

18. The method of claim 15, wherein iteratively identifying and removing successive values in the special Gray list further comprises determining when a size of the special Gray list is equal to the number of packets and storing the special Gray list.

19. The method of claim 15, wherein iteratively identifying and removing successive values in the special Gray list comprises:
identifying a pair of Gray code values, the pair of Gray code values appearing between a first Gray code value and second Gray code value;
determining that the pair of Gray code values can be removed when the first Gray code value and second Gray code value can be adjacent to one another without affecting conformance with a Gray encoding; and
removing the pair of Gray code values to generate a new special Gray list.

20. The method of claim 15, wherein iteratively identifying and removing successive values in the special Gray list comprises analyzing successive pairs of Gray code values from one of a beginning of the Gray coding or an ending of the Gray coding.
